(19) United States
(12) Patent Application Publication
(10) Pub. No.: US 2018/0107140 A1
(43) Pub. Date: Apr. 19, 2018

(54) FUSER MEMBERS

(71) Applicant: Xerox Corporation, Norwalk, CT (US)

(72) Inventors: Jin Wu, Pittsford, NY (US); Lin Ma, Pittsford, NY (US)

(73) Assignee: Xerox Corporation, Norwalk, CT (US)

(21) Appl. No.: 15/292,961

(22) Filed: Oct. 13, 2016

(51) Int. Cl. G03G 15/20

(52) U.S. Cl. CPC G03G 15/206

(57) ABSTRACT

A fuser member comprising a polyimide nanosheet and at least one boron nitride nanosheet.

This disclosure is generally directed to fuser members useful in electrophotographic imaging apparatuses, including xerographic printing systems, digital, image on image, and transfix solid ink jet printing systems, and where the fuser member is comprised of a polyimide and a boron nitride nanosheet.

### BACKGROUND

Methods of manufacturing nanosheets are well known, see for example U.S. Pat. No. 9,150,416 which discloses a method of manufacturing a boron nitride nanosheet; and see also U.S. Pat. No. 8,785,092 which discloses methods of manufacturing titania nanosheets, the disclosures of each of these two patents being incorporated herein by reference as applicable to the nanosheet methods and manufacturing methods each discloses.

In the process of xerography, a light image of an original to be copied is typically recorded in the form of a latent electrostatic image upon a photosensitive or a photoconductive member with subsequent rendering of the latent image visible by the application of a toner composition. The resulting visual toner image can be either fixed directly upon the photoconductor member, or transferred from the member to another support, such as a sheet of plain paper, with subsequent affixing by, for example, the application of heat and pressure of the image thereto.

To affix or fuse toner material onto a support member like paper by heat and pressure, it is usually necessary to elevate the temperature of the toner and simultaneously apply pressure sufficient to cause the constituents of the toner to become tacky and coalesce. In both the xerographic as well as the electrographic recording arts, the use of thermal energy for fixing toner images onto a support member is known. Thus, to permanently fuse electroscopic toner onto a support surface, it is usually necessary to elevate the temperature of the toner to a point at which the constituents of the toner coalesce and become tacky. This heating causes the toner to flow to some extent into the fibers or pores of the support member. Thereafter, as the toner cools, solidification of the toner causes it to be firmly bonded to the support member like paper.

More specifically, the thermal fusing of electroscopic toner images includes providing heat and pressure substantially concurrently by various means, including a roll pair maintained in pressure contact, a belt member in pressure contact with a roll, and the like. Heat may be applied by heating one or both of the rolls, plate members or belt members. The fusing of the toner particles generally takes place when the appropriate combination of heat, pressure, and contact time are provided.

One approach to the heat and pressure fusing of toner images onto a support has been to pass the support with the developed toner images thereon between a pair of pressure engaged roller members, at least one of which is internally heated. For example, the support may pass between a fuser roller and a pressure roller. During operation of a fusing system of this type, the support member to which the toner images are electrostatically adhered is moved through the nip formed between the rollers with the toner image contacting the fuser roll thereby to effect heating of the toner images within the nip.

Typically, thermoplastic resin particles are fused to a substrate by heating to a temperature of from about 90° C. to about 160° C. or higher, depending upon the softening range of the particular resin present in the toner. It may not be desirable, however, to raise the temperature of the substrate substantially higher than about 200° C. primarily because of the tendency of the substrate to discolor at such elevated temperatures particularly when the substrate is paper.

It is desirable in the fusing process that no or minimum offset of the toner particles from the support to the fuser member takes place during normal operations. Toner particles offset onto the fuser member may subsequently transfer to other parts of a xerographic machine or onto the support in subsequent copying and printing cycles.

Hot offset occurs when the temperature of the toner is raised to a point where the toner particles liquefy and a splitting of the molten toner takes place during the fusing operation with a portion of the toner remaining on the fuser member. The hot offset temperature is a measure of the release property of the fuser member, and accordingly, it is desirable to provide a fusing surface that has a low surface energy to permit the efficient release of toner. To ensure and maintain good release properties for the fuser member, it is known to apply release agents thereto to ensure that the toner is completely released from the fuser member during the fusing operation. Typically, these release agents are applied as thin films of, for example, silicone oils. In addition to preventing hot offset, it is desirable to provide a large temperature operational latitude. By operational latitude, it is intended to mean, for example, the difference in temperature between the minimum temperature required to fix the toner to the paper, often referred to as the minimum fix temperature, and the temperature at which the hot toner will offset to the fuser member, or the hot offset temperature.

In use, desirable properties of fuser members include excellent thermal conductivity and acceptable mechanical properties such as hardness. A high fuser member thermal conductivity is of value because, for example, the fuser member should provide sufficient controlled heat to the toner particles for fusing. Also, the fuser member should retain its desired rigidity and elasticity without being degraded in a short period of time. To increase the thermal conductivity of a fuser member, it has been conventional to add conductive filler particles, such as metal oxides or metallic fillers, however, the filler loading, up to 60 percent, can be substantial which tends to adversely affect the mechanical properties of the fuser member and renders this member less resistant to wear.

There is a need for fusing members that substantially avoid or minimize the disadvantages of a number of known fusing members.

Also, there is a need for fuser members, such as fuser belts, that possess an increased thermal conductivity, an excellent thermal diffusivity, and a higher modulus, than a number of known fuser members, thereby allowing in xerographic systems reduced energy consumption, increased fusing speeds and increased toner fusing latitude, and where toner compositions with higher melting temperatures, and where lower cost toners can be used.

There is a need for fuser member mixtures where there is enhanced the thermal and electrical conductivity properties thereof, and where the fuser member possesses robust mechanical properties.

Additionally, there is a need for fuser members that permit toner compositions to fuse at low temperatures, and that allow wider toner fusing temperature latitudes.

Yet further, there is a need for fusing members where a multitude of different toner compositions can be used resulting in decreased costs to manufacturers and to consumers.

Furthermore, there is a need for fuser members where toner offset is minimal, or where toner offset is avoided in xerographic imaging and printing systems.

Moreover, there is a need for fuser belts that can be prepared by current manufacturing methods, and with little or no capital investments.

There is also a need for economical endless seamless fusing members, that is with an absence of any seams or visible joints in the members, that are selected for the heat fusing of developed images in xerographic processes.

Also, there is a need for fuser members with superb mechanical properties, outstanding thermal conductivity characteristics, and excellent stability over extended time periods.

A need also exists to minimize the repair or replacement of fuser members by increasing or improving the thermal conductivity characteristics thereof.

These and other needs are achievable in embodiments with the fuser members and components thereof disclosed herein.

### SUMMARY

Disclosed is a fuser member comprising a polyimide and a boron nitride nanosheet.

Also, disclosed is a xerographic fuser member comprising at least one layer comprising a mixture of a polyimide and at least one boron nitride nanosheet.

Further disclosed is a xerographic fuser member comprising at least one layer comprising a mixture of a polyimide and a boron nitride nanosheet and wherein said polyimide is represented by at least one of the following formulas/structures

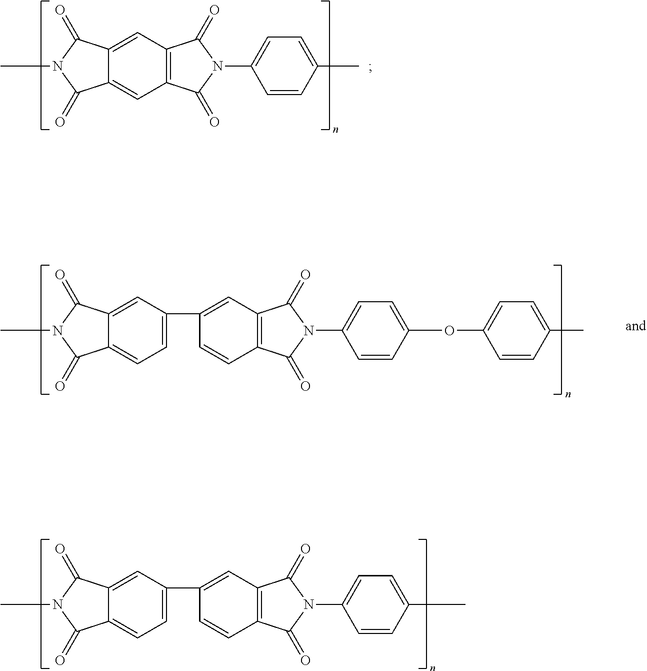

wherein n represents the number of repeating groups of from about 5 to about 3,000.

Yet, further disclosed is a xerographic fuser member comprising from one to about 10 separate layers with each layer comprising a mixture of a polyimide and a boron nitride nanosheet or boron nitride nanosheets.

Further, disclosed is a xerographic fuser belt comprising a mixture of a polyimide and a boron nitride nanosheet, inclusive of nanosheets, and wherein the mixture has a thermal conductivity increase versus a fuser belt that is comprised of a polyimide and a carbon nanotube or a graphene.

### FIGURES

The following Figures are provided to further illustrate the fuser members disclosed herein.

FIG. 1 illustrates an exemplary embodiment of a fuser member of the present disclosure.

FIG. 2 illustrates an exemplary embodiment of a two layered fuser member of the present disclosure.

FIG. 3 illustrates an exemplary embodiment of a three layered fusing member of the present disclosure.

### EMBODIMENTS

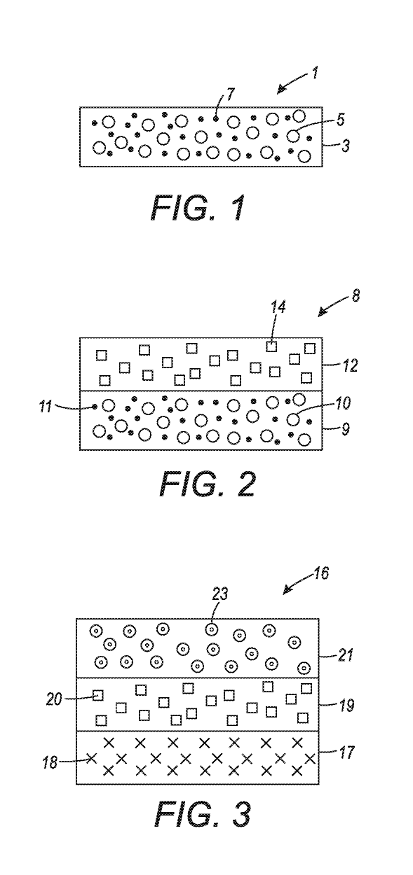

In FIG. 1, an exemplary embodiment of the present disclosure, there is illustrated a fuser member 1 comprising a layer 3, containing a polyimide 5, and boron nitride nanosheet components 7.

In FIG. 2, an exemplary embodiment of the present disclosure, there is illustrated a two layered fuser member 8 comprising a first layer 9, containing a mixture of a polyimide 10, and boron nitride nanosheet components 11, and a second layer 12 comprising at least one silicone polymer 14.

In FIG. 3, an exemplary embodiment of the present disclosure, there is illustrated a three layered fuser member 16, comprising a first layer 17 containing a mixture of a polyimide and at least one boron nitride nanosheet 18, an optional intermediate layer or functional layer 19 comprising silicone polymers 20, and an optional surface layer 21 comprising fluoropolymers 23.

Boron Nitride Nanosheets

There exist a number of publications that illustrate the preparation of a boron nitride nanosheet (BNNS, sometimes referred to as white graphene), which can be selected for the disclosed herein fuser members, such as the article “Large Scale Fabrication of Boron Nitride Nano Sheets”, Advanced Materials, 2009, 2889-2893 with the listed authors of Chunyi Zhi, Yoshio Bando, Chengchun Tang, Hiroaki Kuwanhara, and Dimitri Goldberg and “Boron Nitride Nanosheets Novel Synthesis and Applications in Polymer Composites”, 18^{th} Microscopy Conference, Journal Of Physics Conference Series 47 (2013) 102003 with the listed authors Xuebin Wang, Chunyi Zhi, Qunhong Weng, Yoshio Bando and Dimitri Goldberg.

Nanosheet refers, for example, to a dimensional nanostructure with a thickness of, for example, from 1 to about 100 nanometers with a known specific example of nanosheet being graphene, a thin, about 0.34 nanometer that comprises a single layer of carbon atoms with hexagonal lattices.

The polyimide boron nitride nanosheet can be included in a number of separate layers, such as for example, from about one (1) layer to about 10 layers, from about 1 layer to about 6 layers, or from about 1 layer to 3 layers, and where each layer has a thickness, for example, of from about 10 to about 125 microns, from about 20 to about 100 microns, or from about 40 to about 65 microns.

The boron nitride nanosheet is present in the polyimide containing mixture in an amount, for example, of from about 0.01 to about 10 weight percent, from about 0.01 to about 5 weight percent, from about 0.5 to about 5 weight percent, from about 0.1 to about 10 weight percent, from about 0.1 to about 0.5 weight percent, from about 0.02 to about 0.05 weight percent, from about 0.03 to about 0.3 weight percent, from about 0.01 to about 0.05 weight percent, from about 0.02 to about 1 weight percent, from about 0.05 to about 1 weight percent, from about 0.01 to about 1 weight percent, from about 1 to about 3 weight percent, and from about 1 to about 3 weight percent based on the percent solids of, for example, the boron nitride nanosheet and the polyimide polymer.

The weight ratio of the polyimide boron nitride nanosheet can be, for example, from about 90/10 to about 99.9/0.1 or from about 99.5/0.5.

Polyimides

Examples of polyimides that in embodiments form a mixture with the boron nitride nanosheet, within which the disclosed boron nitride nanosheet can be dispersed, or where the boron nitride nanosheet is incorporated in the polyimide, include known low temperature, and rapidly cured polyimide polymers, such as VTEC™ PI 1388, 080-051, 851, 302, 203, 201, and PETI-5, all available from Richard Blaine International, Incorporated, Reading, Pa., and the like. The thermosetting polyimides selected can be cured at temperatures of from about 180° C. to about 260° C. over a period of time, such as from about 10 to about 120 minutes, or from about 30 to about 60 minutes, and generally have a number average molecular weight of from about 5,000 to about 500,000, or from about 10,000 to about 100,000, and a weight average molecular weight of from about 50,000 to about 5,000,000, or from about 100,000 to about 1,000,000, as determined by GPC or as reported by the entities that prepare these polyimides. Also, there can be selected thermosetting polyimides that can be cured at temperatures of above 300° C., such as PYRE M.L.® RC-5019, RC-5057, RC-5069, RC-5097, and RC-5053, all commercially available from Industrial Summit Technology Corporation, Parlin, N.J.; RP-46 and RP-50, both commercially available from Unitech LLC, Hampton, Va.; DURIMIDE® 100, commercially available from FUJIFILM Electronic Materials U.S.A., Inc., North Kingstown, R.I.; and KAPTON® HN, VN and FN, all commercially available from E.I. DuPont, Wilmington, Del.

Further, polyimides selected for the fuser members illustrated herein can be formed by imidization of a polyimide precursor of a polyamic acid that includes one of a polyamic acid of pyromellitic dianhydride/4,4′-oxydianiline, a polyamic acid of pyromellitic dianhydride/phenylenediamine, a polyamic acid of biphenyl tetracarboxylic dianhydride/4,4′-oxydianiline, a polyamic acid of biphenyl tetracarboxylic dianhydride/4,4′-diaminobenzene, a polyamic acid of biphenyl tetracarboxylic dianhydride/phenylenediamine, a polyamic acid of benzophenone tetracarboxylic dianhydride/4,4′-oxydianiline, a polyamic acid of benzophenone tetracarboxylic dianhydride/4,4′-oxydianiline/phenylenediamine, and the like, and mixtures thereof. After curing, the resulting polyimides include a polyimide of pyromellitic dianhydride/4,4′-oxydianiline, a polyimide of pyromellitic dianhydride/phenylenediamine, a polyimide of biphenyl tetracarboxylic dianhydride/4,4′-oxydianiline, a polyimide of biphenyl tetracarboxylic dianhydride/phenylenediamine, a polyimide of benzophenone tetracarboxylic dianhydride/4,4′-oxydianiline, a polyimide of benzophenone tetracarboxylic dianhydride/4,4′-oxydianiline/phenylenediamine, and mixtures thereof.

Specific examples of polyamic acids selected for imidization with a polyimide precursor include a polyamic acid of pyromellitic dianhydride/4,4-oxydianiline, with the trade name of PYRE-M.L.®, RC-5019 (about 15 to 16 weight percent in N-ethyl-2-pyrrolidone, NMP), RC-5083 (about 18 to 19 weight percent in NMP/DMAc 15/85), or RC-5057 (about 14.5 to 15.5 weight percent in NMP/aromatic hydrocarbon 80/20), and all commercially available from Industrial Summit Technology Corporation, Parlin, N.J.; a polyamic acid of biphenyl tetracarboxylic dianhydride/p-diaminobenzene, commercially available as U-VARNISH A and S (about 20 weight percent in NMP), both available from UBE America Incorporated, New York, N.Y., or available from Kaneka Corporation, Texas; PI-2610 (about 10.5 weight percent in NMP), and PI-2611 (about 13.5 weight percent in NMP), both available from HD MicroSystems, Parlin, N.J.; DURIMIDE® 100, commercially available from FUJIFILM Electronic Materials Incorporated, United States, mixtures thereof, and the like.

More specifically, polyamic acid or esters of polyamic acid examples that can be selected for the formation of a polyimide are prepared by the reaction of a dianhydride and a diamine. Suitable dianhydrides selected include aromatic dianhydrides and aromatic tetracarboxylic acid dianhydrides, such as, for example, 9,9-bis(trifluoromethyl)xanthene-2,3,6,7-tetracarboxylic acid dianhydride, 2,2-bis(3,4-dicarboxyphenyl)hexafluoropropane dianhydride, 2,2-bis((3,4-dicarboxyphenoxy) phenyl)hexafluoropropane dianhydride, 4,4′-bis(3,4-dicarboxy-2,5,6-trifluorophenoxy) octafluorobiphenyl dianhydride, 3,3′,4,4′-tetracarboxybiphenyl dianhydride, 3,3′,4,4′-tetracarboxybenzophenone dianhydride, di-(4-(3,4-dicarboxyphenoxy)phenyl)ether dianhydride, di-(4-(3,4-dicarboxyphenoxy)phenyl) sulfide dianhydride, di-(3,4-dicarboxyphenyl)methane dianhydride, di-(3,4-dicarboxyphenyl)ether dianhydride, 1,2,4,5-tetracarboxybenzene dianhydride, 1,2,4-tricarboxybenzene dianhydride, butanetetracarboxylic dianhydride, cyclopentanetetracarboxylic dianhydride, pyromellitic dianhydride, 1,2,3,4-benzenetetracarboxylic dianhydride, 2,3,6,7-naphthalenetetracarboxylic dianhydride, 1,4,5,8-naphthalenetetracarboxylic dianhydride, 1,2,5,6-naphthalenetetracarboxylic dianhydride, 3,4,9,10-perylenetetracarboxylic dianhydride, 2,3,6,7-anthracene tetracarboxylic dianhydride, 1,2,7,8-phenanthrenetetracarboxylic dianhydride, 3,3′,4,4′-biphenyltetracarboxylic dianhydride, 2,2′,3,3′-biphenyltetracarboxylic dianhydride, 3,3′,4,4′-benzophenonetetracarboxylic dianhydride, 2,2′,3,3′-benzophenonetetracarboxylic dianhydride, 2,2-bis(3,4-dicarboxyphenyl)propane dianhydride, 2,2-bis(2,3-dicarboxyphenyl)propane dianhydride, bis(3,4-dicarboxyphenyl)ether dianhydride, bis(2,3-dicarboxyphenyl)ether dianhydride, bis(3,4-dicarboxyphenyl)sulfone dianhydride, bis(2,3-dicarboxyphenyl)sulfone 2,2-bis(3,4-dicarboxyphenyl)-1,1,1,3,3,3-hexafluoropropane dianhydride, 2,2-bis(3,4-dicarboxyphenyl)-1,1,1,3,3,3-hexachloropropane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)methane dianhydride, 4,4′-(p-phenylenedioxy) diphthalic dianhydride, 4,4′-(m-phenylenedioxy)diphthalic dianhydride, 4,4′-diphenylsulfidedioxybis(4-phthalic acid)dianhydride, 4,4′-diphenylsulfonedioxybis(4-phthalic acid)dianhydride, methylenebis(4-phenyleneoxy-4-phthalic acid)dianhydride, ethylidenebis(4-phenyleneoxy-4-phthalic acid)dianhydride, isopropylidenebis(4-phenyleneoxy-4-phthalic acid)dianhydride, hexafluoroisopropylidenebis(4-phenyleneoxy-4-phthalic acid)dianhydride, and the like.

Exemplary diamines selected suitable for use in the preparation of the polyamic acid include 4,4′-bis-(m-aminophenoxy)-biphenyl, 4,4′-bis-(m-aminophenoxy)-diphenyl sulfide, 4,4′-bis-(m-aminophenoxy)-diphenyl sulfone, 4,4′-bis-(p-aminophenoxy)-benzophenone, 4,4′-bis-(p-aminophenoxy)-diphenyl sulfide, 4,4′-bis-(p-aminophenoxy)-diphenyl sulfone, 4,4′-diamino-azobenzene, 4,4′-diaminobiphenyl, 4,4′-diaminodiphenylsulfone, 4,4′-diamino-p-terphenyl, 1,3-bis-(gamma-aminopropyl)-tetramethyl-disiloxane, 1,6-diaminohexane, 4,4′-diaminodiphenylmethane, 3,3′-diaminodiphenylmethane, 1,3-diaminobenzene, 4,4′-diaminodiphenylether, 2,4′-diaminodiphenylether, 3,3′-diaminodiphenylether, 3,4′-diaminodiphenylether, 1,4-diaminobenzene, 4,4′-diamino-2,2′,3,3′,5,5′,6,6′-octafluoro-biphenyl, 4,4′-diamino-2,2′,3,3′,5,5′,6,6′-octafluorodiphenyl ether, bis[4-(3-aminophenoxy)-phenyl] sulfide, bis[4-(3-aminophenoxy)phenyl] sulfone, bis[4-(3-aminophenoxy)phenyl] ketone, 4,4′-bis(3-aminophenoxy)biphenyl, 2,2-bis[4-(3-aminophenoxy)phenyl]-propane, 2,2-bis[4-(3-aminophenoxy)phenyl]-1,1,1,3,3,3-hexafluoropropane, 4,4′-diaminodiphenyl sulfide, 4,4′-diaminodiphenyl ether, 4,4′-diaminodiphenyl sulfone, 4,4′-diaminodiphenyl methane, 1,1-di(p-aminophenyl) ethane, 2,2-di(p-aminophenyl)propane, and 2,2-di(p-aminophenyl)-1,1,1,3,3,3-hexafluoropropane, and the like, and mixtures thereof.

Examples of commercially available polyimide precursors of biphenyl tetracarboxylic dianhydride/phenylenediamine include PI-2610 (about 10.5 weight in NMP), and PI-2611 (about 13.5 weight in NMP), both available from HD MicroSystems, Parlin, N.J.; and BPDA resin (about 16.5 weight percent in the solvent NMP) obtainable from Kaneka Corporation.

The dianhydrides and diamines are, for example, selected in a weight ratio of from about 20:80 to about 80:20, and more specifically, in an about 50:50 weight ratio.

Polyimide examples selected for the disclosed fuser members are as represented by at least one of the following formulas/structures, and mixtures thereof

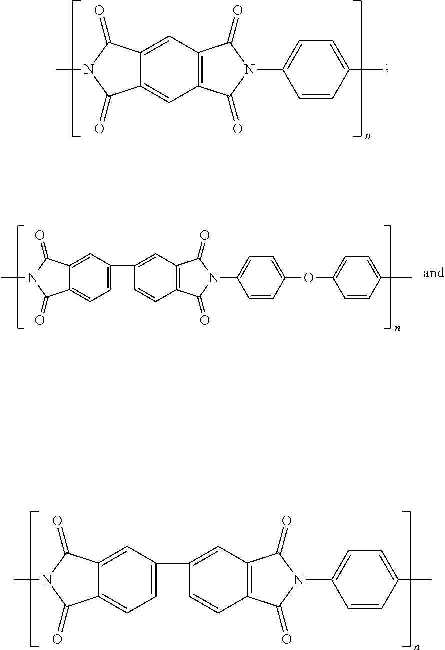

where n represents the number of repeating units, or segments of, for example, from about 5 to about 3,000, from about 50 to about 2,000, from about 50 to about 1,500, from about 200 to about 1,200, from about 1,000 to about 2,000, from about 1,200 to about 1,800, or from about 250 to about 300.

The polyimide can be present in various effective amounts, and where the total of the polyimide, the boron nitride nanosheet, and optional components when present, is equal to about 100 weight percent. Thus, for example, the polyimide can present in an amount of from about 90 weight percent to about 99.9 weight percent based on the solids.

Optional Silicone Intermediate Layer

Examples of optional silicones selected for the layer in contact with, for example, the top layer of the polyimide/boron nitride nanosheet, and referred to as an intermediate layer, include fluorosilicones, silicone rubbers, such as room temperature vulcanization (RTV) silicone rubbers, high temperature vulcanization (HTV) silicone rubbers, and low temperature vulcanization (LTV) silicone rubbers. These rubbers are known and readily available commercially, such as SILASTIC® 735 black RTV and SILASTIC® 732 RTV, both from Dow Corning; 106 RTV Silicone Rubber and 90 RTV Silicone Rubber, both available from General Electric; and JCR6115CLEAR HTV and SE4705U HTV silicone rubbers available from Dow Corning Toray Silicones.

Other suitable optional silicone materials that can be selected for the intermediate layer include siloxanes (such as polydimethylsiloxanes); fluorosilicones such as Silicone Rubber 552, available from Sampson Coatings, Richmond, Va.; liquid silicone rubbers such as vinyl crosslinked heat curable rubbers or silanol room temperature crosslinked materials; Dow Corning SYLGARD 182, commercially available LSR rubbers such as Dow Corning Q3-6395, Q3-6396, SILASTIC® 590 LSR, SILASTIC® 591 LSR, SILASTIC® 595 LSR, SILASTIC® 596 LSR, and SILASTIC® 598 LSR. The functional layer provides, for example, elasticity, and this layer can include inorganic particles, for example SiC or Al₂O₃, as required.

The thickness of the silicone layer is, for example, from about 25 microns to about 1,000 microns, from about 100 microns to about 700 microns, or from about 150 microns to about 500 microns as determined by known methods such as measurement with a Permascope. A number of known methods may be used to apply or coat the silicone layer on the polyimide and boron nitride nanosheet layer, such as for example, spraying, flow coating from a solvent mixture thereof, and the like.

Optional Fluoropolymers

Examples of suitable optional fluoropolymers in contact with the silicone layer for the disclosed fuser members can include, but are not limited to i) copolymers of vinylidenefluoride and hexafluoropropylene; ii) terpolymers of vinylidenefluoride, hexafluoropropylene and tetrafluoroethylene; and iii) tetrapolymers of vinylidenefluoride, hexafluoropropylene, tetrafluoroethylene, and a cure site monomer.

Optional specific fluoropolymer examples selected for the disclosed fuser members include tetrafluoroethylene polymers (PTFE), trifluorochloroethylene polymers, hexafluoropropylene polymers, vinyl fluoride polymers, vinylidene fluoride polymers, difluorodichloroethylene polymers or copolymers thereof, perfluoroalkoxy polymers (PFA), copolymers of tetrafluoroethylene (TFE) and hexafluoropropylene (HFP), copolymers of hexafluoropropylene (HFP) and vinylidene fluoride (VDF or VF₂), terpolymers of tetrafluoroethylene (TFE), vinylidene fluoride (VDF) and hexafluoropropylene (HFP), and tetrapolymers of tetrafluoroethylene (TFE), vinylidene fluoride (VF₂), and hexafluoropropylene (HFP), and mixtures thereof; copolymers of vinylidenefluoride, hexafluoropropylene, and tetrafluoroethylene, like those available as VITON A®; terpolymers of vinylidenefluoride, hexafluoropropylene, and tetrafluoroethylene known commercially as VITON B®; and tetrapolymers of vinylidenefluoride, hexafluoropropylene, tetrafluoroethylene, and a cure site monomer, available as VITON GH® or VITON GF®; VITON E®, VITON E 60C®, VITON E430®, VITON 910®, and VITON ETP®. The cure site monomer can be 4-bromoperfluorobutene-1, 1,1-dihydro-4-bromoperfluorobutene-1, 3-bromoperfluoropropene-1, 1,1-dihydro-3-bromoperfluoropropene-1, or any other suitable known cure site monomer, such as those commercially available from E.I. DuPont.

Commercially available fluoropolymers that can be selected for the disclosed fuser members include, in addition to TEFLON®, available from E.I. DuPont de Nemours, Inc. is FLUOREL 2170®, FLUOREL 2174®, FLUOREL 2176®, FLUOREL 2177® and FLUOREL LVS 76®, FLUOREL® being a registered trademark of 3M Company; AFLAS™ a poly(propylene-tetrafluoroethylene), and FLUOREL II® (LII900) a poly(propylene-tetrafluoroethylenevinylidenefluoride), both available from 3M Company; the Tecnoflons identified as FOR-60KIR®, FOR-LHF®, NM®, FOR-THF®, FOR-TFS®, TH®, NH®, P757®, TNS®, T439®, PL958®, BR9151® and TN505®, all available from Ausimont Inc.

The thickness of the fluoropolymer layer is, for example, from about 25 microns to about 1,000 microns, from about 100 microns to about 700 microns, or from about 150 microns to about 500 microns as determined by known methods such as measurement with a Permascope. A number of known methods may be used to apply or coat the fluoropolymer layer on the silicone layer, such as for example, spraying, flow coating from a solvent mixture thereof, and the like.

Solvents

For the preparation of the disclosed fuser members, inclusive of those in the configuration of a belt, and the layer or layers thereof, there can be selected various suitable solvents including, but not limited to methyl ethyl ketone (MEK), methyl isobutyl ketone (MIBK), methyl-tertbutyl ether (MTBB), methyl n-amyl ketone (MAK), tetrahydrofuran (THF), water, alkalis, methyl alcohol, ethyl alcohol, acetone, ethyl acetate, butyl acetate, or any other low molecular weight carbonyls; polar solvents, Wittig reaction solvents such as dimethyl formamide (DMF), dimethyl sulfoxide (DMSO) and N-methyl 2 pyrrolidone (NMP), mixtures thereof, and the like. The solvent is selected, for example, in an amount of from about 70 to about 95 weight percent, or from 80 to about 90 weight percent based on the amounts of component in the coating mixture, and more specially, where there results, for example, from about 10 to about 25, from about 15 to about 20 weight percent solids.

For example, there can be first dissolved or dispersed the polyimide polymer in a suitable solvent, followed by adding the boron nitride nanosheet, in an amount sufficient to provide the desired properties, such as the desired thermal conductivity and improved mechanical strength. The mixing and dissolving can be accomplished by mechanical processes, such as by using an agitation sonication or attritor, ball milling/grinding, to facilitate the mixing of the dispersion.

Fuser Member Preparation

The disclosed fuser member can be prepared as illustrated herein, such as by the flow coating of the polyimide and the boron nitride nanosheet mixture on a suitable substrate. Thus, the polyimide/boron nitride nanosheet composition can be flow coated on a seamless or welded stainless steel cylinder, a welded or seamless stainless steel belt, a seamless aluminum belt or drum, an electroformed seamless nickel belt or drum, a diamond like carbon-coated metal substrate, a glass drum, or a glass cylinder, or the outer surface of a rotating substrate. The resulting polyimide/boron nitride nanosheet product can then be partially cured, or pre-cured, and then fully cured as illustrated herein. For multilayered polyimide boron nitride nanosheet layers, each separate layer can be prepared as disclosed herein, such as by flow coating.

The disclosed fuser member mixture of, for example, a polyimide and the boron nitride nanosheet can also be coated on a substrate by liquid spray coating, dip coating, wire wound rod coating, fluidized bed coating, powder coating, electrostatic spraying, sonic spraying, blade coating, molding, laminating, and the like.

The cured polyimide and boron nitride nanosheet mixture self-releases from the disclosed substrates with full separation of, for example, from about 90 to about 100 percent, or from about 95 to about 99 percent.

Specific embodiments will now be described in detail. These examples are intended to be illustrative, and not limited to the materials, conditions, or process parameters set forth in these embodiments. All parts are percentages by solid weight unless otherwise indicated.

### Example I

There is prepared by flow coating or with a high shear mixer a fuser member by mixing the polyamic acid of biphenyl tetracarboxylic dianhydride/p-benzenedianiline available from Kaneka, about 16.6 weight percent in the solvent NMP, and a NMP solvent containing the boron nitride nanosheet (BNNS) prepared as illustrated herein at the weight ratio of 99.5/0.5 polyamic acid/boron nitride nanosheet, and where the boron nitride nanosheet is incorporated in the polyamic acid solution. After flow coating the resulting mixture onto on a stainless steel rigid cylindrical mandrel substrate, the mixture resulting is subsequently pre-cured at about 220° C. for about 75 minutes, followed by a final curing at a temperature at about 325° C. for about 60 minutes, then cooled to room temperature, about 25° C. The Kaneka Corporation polyamic acid converts after pre-curing and then final curing into the polyimide of biphenyl tetracarboxylic dianhydride/4,4′-diaminobenzene (BPDA) as represented by the following formula/structure.

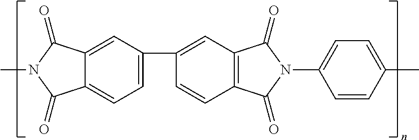

where n is about 300.

The obtained polyimide/boron nitride nanosheet fuser belt (weight ratio of polyimide/boron nitride nanosheet: 99.5/0.5) self-releases, it is believed, from the stainless steel rigid cylindrical mandrel substrate in about 5 seconds, and a 60 micron thick smooth polyimide/boron nitride nanosheet member mixture is obtained, and which fuser member is incorporated into a xerographic machine for the fusing of xerographic toner developed images as disclosed herein.

It is believed that both the thermal conductivity, and mechanical integrity of the above prepared polyimide and boron nitride nanosheet fuser belt will be significantly improved versus, for example, a polyimide/carbon nanotube fuser member.

The enhanced thermal conductivity of the above prepared boron nitride nanosheet containing fuser member can result in a drop in the temperature needed to satisfactorily fuse a toner image to a support like paper. Therefore, it is believed that this fuser member can accomplish the same or equivalent fusing of a toner image to a support sheet at a lower fusing temperature than fusing members free of a boron nitride nanosheet. The lower fusing temperature is advantageous since the fuser member consumes less energy, does not dry out paper, hence less paper curl, achieves improved toner fix and excellent toner coalescence for the same dwell time, extends the fuser member life, reduces power requirements at machine start up and while operating the fuser system.

Additionally, it is believed that the disclosed boron nitride nanosheet fusing members withstand, without significant degradation in their physical properties, a high processing temperature, high mechanical strength, improved heat conducting properties, which improves the thermal efficiency of a fusing system, and tailored electrical properties.

The disclosed fuser member thermal conductivity can be measured by laser flash analysis in Watts per meter Kelvin, and also where the reciprocal of the thermal conductivity is referred to as the thermal resistivity.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

What is claimed is:

1. A fuser member comprising a polyimide and a boron nitride nanosheet.

2. A fuser member in accordance with claim 1 wherein said polyimide boron nitride nanosheet is in the configuration of at least one layer.

3. A fuser member in accordance with claim 2 wherein the weight ratio of said polyimide to said boron nitride nanosheet is from about 90/10 to about 99.9/0.1.

4. A fuser member in accordance with claim 2 wherein the weight ratio of said polyimide to said boron nitride nanosheet is from about 95/5 to about 99.5/0.5.

5. A fuser member in accordance with claim 1 wherein said polyimide is represented by at least one of the following formulas/structures 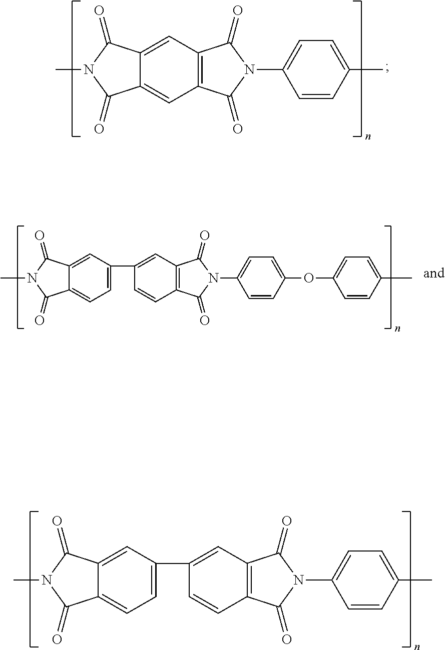
wherein n represents the number of repeating groups.

6. A fuser member in accordance with claim 5 wherein n is a value of from about 5 to about 3,000.

7. A fuser member in accordance with claim 5 wherein n is a value of from about 200 to about 1,200.

8. A fuser member in accordance with claim 5 wherein said polyimide is represented by the following formula/structure 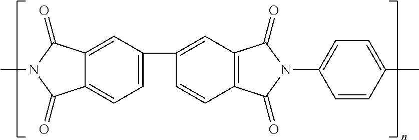
where the value of n is about 300.

9. A fuser member in accordance with claim 2 wherein the boron nitride nanosheet is present in an amount of from about 0.1 to about 10 weight percent of the fuser member, and said at least one layer is from about one layer to about 3 layers.

10. A fuser member in accordance with claim 2 wherein a silicone polymer layer is present on said boron nitride nanosheet layer, and wherein a fluoropolymer is present on said silicone layer.

11. A fuser member in accordance with claim 10 wherein the fluoropolymer is selected from the group consisting of i) a copolymer of vinylidenefluoride and hexafluoropropylene; ii) a terpolymer of vinylidenefluoride, hexafluoropropylene and tetrafluoroethylene; and iii) a tetrapolymer of vinylidenefluoride, hexafluoropropylene, tetrafluoroethylene, and a cure site monomer.

12. A fuser member in accordance with claim 10 wherein the fluoropolymer is a polyfluoroalkoxypolytetrafluoroethylene or polytetrafluoroethylene.

13. A fuser member in accordance with claim 1 wherein said boron nitride nanosheet is present in an amount of from about 0.01 to about 10 weight percent of the fuser member.

14. A xerographic fuser member comprising at least one layer comprising a mixture of a polyimide and at least one boron nitride nanosheet.

15. A xerographic fuser member in accordance with claim 14 wherein said at least one boron nitride nanosheet is present in an amount of from about 0.1 weight percent to about 10 weight percent based on the solids, and said polyimide is present in an amount of from about 99.9 weight percent to about 90 weight percent based on the fuser member.

16. A xerographic fuser member in accordance with claim 14 wherein said polyimide is represented by at least one of the following formulas/structures 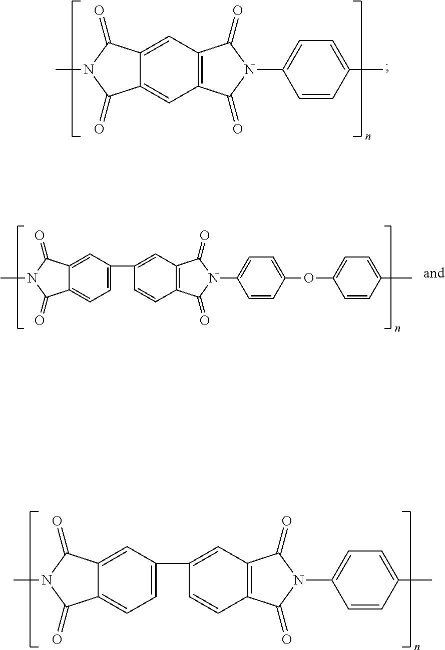
wherein n represents the number of repeating groups of from about 5 to about 3,000.

17. A xerographic fuser member in accordance with claim 14 wherein a silicone layer is provided on the polyimide boron nanosheet layer, and a fluoropolymer layer is provided on the silicone layer.

18. A xerographic fuser member comprising at least one layer comprising a mixture of a polyimide and a boron nitride nanosheet, and wherein said polyimide is represented by at least one of the following formulas/structures 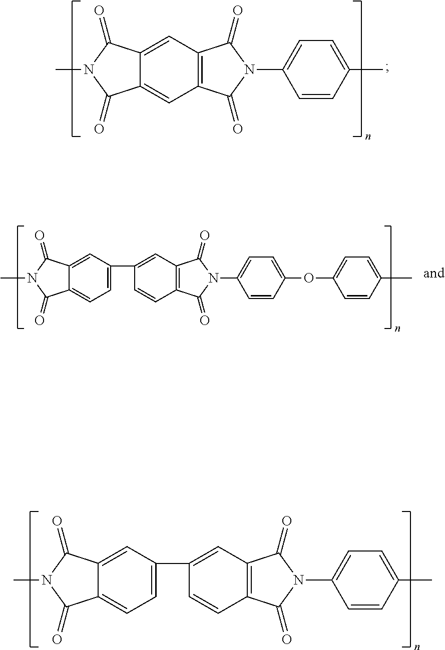
wherein n represents the number of repeating groups of from about 5 to about 3,000.

19. A fuser member in accordance with claim 18 wherein the weight ratio of said polyimide to said boron nitride nanosheet is from about 90/10 to about 99.9/0.1, and wherein said at least one polyimide boron nitride nanosheet comprises from about one layer to about 10 separate layers.

20. A fuser member in accordance with claim 18 wherein the weight ratio of said polyimide to said boron nitride nanosheet is from about 95/5 to about 99.5/0.5.

21. A fuser member in accordance with claim 18 wherein a silicone layer is present on said polyimide boron nitride nanosheet layer, and wherein there is present a fluoropolymer layer on said silicone layer.

22. A fuser member in accordance with claim 1 wherein said polyimide boron nitride nanosheet comprises from about one layer to about 10 separate layers.

23. A fuser member in accordance with claim 1 wherein said polyimide boron nitride nanosheet comprises from about one layer to about 3 separate layers.
